(19) United States
(12) Patent Application Publication
(10) Pub. No.: US 2026/0134065 A1
(43) Pub. Date: May 14, 2026

(54) OWNERSHIP AND COPYRIGHT INTEGRATING NFT SYSTEM BASED ON BLOCKCHAIN IN METAVERSE PLATFORM

(71) Applicant: Du-Heon GYEON, Incheon (KR)

(72) Inventor: Du-Heon GYEON, Incheon (KR)

(21) Appl. No.: 18/957,995

(22) Filed: Nov. 25, 2024

(30) Foreign Application Priority Data
Nov. 13, 2024 (KR) 10-2024-0160886

(51) Int. Cl. G06F 21/10; G06Q 20/36

(52) U.S. Cl. CPC G06F 21/1014; G06Q 20/36

(57) ABSTRACT

An ownership and copyright integrating non-fungible token (NFT) system based on blockchain in a metaverse platform includes an input unit configured to receive NFT information on content based on an NFT, a token management unit configured to generate an NFT matching the received NFT information and provide a history management service for the NFT, rights holder authentication unit configured to integrate ownership and copyright in an equal share ratio and providing the integrated ownership and copyright to a user corresponding to the generated NFT, and a token transaction unit configured to perform NFT transaction with other users on the metaverse platform by using transaction information input by a rights holder to whom the ownership and copyright are provided, generate transaction completion information when NFT transaction is completed, and broadcast the transaction completion information to a blockchain network.

### CROSS-REFERENCE TO RELATED APPLICATION

This application is based on and claims priority under 35 U.S.C. § 119 to Korean Patent Application No. 10-2024-0160886, filed on Nov. 13, 2024, in the Korean Intellectual Property Office, the disclosure of which is incorporated by reference herein in its entirety.

### BACKGROUND OF THE INVENTION

The present disclosure relates to an ownership and copyright integrating non-fungible token (NFT) system based on blockchain in a metaverse platform, and more specifically, to an ownership and copyright integrating NFT system that integrates concepts of ownership and copyright to perform a transaction on contents.

Recently, various studies and inventions utilizing the metaverse have been conducted. Metaverse is a compound word of the English words “meta” meaning “virtual” and “transcendence”, and “universe”, and refers to a virtual world where social, economic, and cultural activities similar to the real world take place.

The metaverse is a concept that is advanced one step more than virtual reality (VR), and has the characteristic that the metaverse allows not only enjoying games or virtual reality using avatars, but also engaging in social and cultural activities similar to real reality. Also, the concept of non-fungible token (NFT), which may guarantee intellectual property rights or uniqueness of digital content generated in the metaverse described above, has been introduced, and much related research is being conducted.

The NFT means a non-fungible token and represents a digital asset with scarcity and has the characteristic of being non-interchangeable because the NFT gives a separate unique recognition value to the digital asset, unlike existing virtual assets. In other words, the NFT is based on blockchain, and all related information such as ownership and sales history are stored on the blockchain, and accordingly, an original issuer may be checked at any time, making forgery impossible. In particular, NFT-related technology is highly evaluated for its usability in virtual reality such as metaverse or games.

Currently, the NFT content ecosystem is overflowing with countless contents that have not gone through any quality, copyright verification, or official announcement procedures, and this verification process itself is virtually impossible.

In addition, in the online and metaverse content industry, not offline artwork, content ownership is virtually meaningless, and what has real value is copyright, not ownership.

In addition, since ownership and copyright are completely separate concepts, users acquire ownership by paying a high price after purchasing NFTs, but may not exercise any form of real authority. That is, there was a problem in that, even when a user purchases unbelievable content for an unbelievable amount of money, there was no real and permanent right to be guaranteed.

The background technology of the present disclosure is disclosed in Korean Patent Publication No. 10-2386896 (published on Apr. 15, 2022).

### SUMMARY OF THE INVENTION

The present disclosure provides an ownership and copyright integrating NFT system that performs transactions for content by integrating the concepts of ownership and copyright.

According to an aspect of the present disclosure, an ownership and copyright integrating non-fungible token (NFT) system based on blockchain in a metaverse platform includes an input unit configured to receive NFT information on content based on an NFT, a token management unit configured to generate an NFT matching the received NFT information and provide a history management service for the NFT, a rights holder authentication unit configured to integrate ownership and copyright in an equal share ratio and providing the integrated ownership and copyright to a user corresponding to the generated NFT, and a token transaction unit configured to perform NFT transaction with other users on the metaverse platform by using transaction information input by a rights holder to whom the ownership and copyright are provided, generate transaction completion information when NFT transaction is completed, and broadcast the transaction completion information to a blockchain network, wherein the token transaction unit performs a sale for shares of a requested transaction while performing a sequentially rotation when multiple rights holders request a sale for token transaction.

The ownership and copyright integrating NFT system may further include a digital wallet management unit configured to collect NFT information held by the multiple rights holders and usage rights information on digital wallets set by each of the multiple rights holders and configured to perform conversion management between a hot wallet and a cold wallet.

The token transaction unit may perform the sale in an equal share unit of the multiple rights holders while performing the sequential rotation.

The token transaction unit may perform the sale in proportion to share ratios owned by the multiple rights holders while performing the sequential rotation.

A minimum transaction unit of the shares may be 0.01%, and the multiple rights holders may perform the sale by 1% for each rights holder while performing the sequential rotation.

The token transaction unit may automatically notify other rights holders of share price per % when a largest share holder among the multiple rights holders determines the share price per %, automatically activate a transaction of a corresponding rights holder when the share price per %is included in a share price range directly set by another rights holder, and automatically deactivate transaction activation setting for the corresponding rights holder when the share price per % is not included in the set share price range.

The token transaction unit may deactivate the transaction of another rights holder who does not agree with the share price per % when the largest share holder among the multiple rights holders determines the share price per %.

When the largest share holder is not engaged in the transaction for a certain period of time while the share price per % is determined, the token transaction unit may release the transaction activation settings of all rights holders and determines the share price per % based on an average profit of a corresponding content for a certain period of time for the content through an automatic valuation method.

In the automatic valuation method, each rights holder may set the shares for transaction again to request a sale.

In the automatic valuation method, transaction activation settings of all rights holders may be maintained even when the largest share holder is not engaged in the transaction for a certain period of time.

The NFT information may include at least one of content information including an image, a video, music, modeling, digital real estate, and a game, information in which copyright and ownership of content are integrated, and share ratio information of a rights holder and other users.

The token management unit may generate an NFT to which a random unique key is assigned in response to the NFT information, match the generated NFT to integrated copyright and ownership information, and store the matched information, and detects external access or abnormal access by using the random unique key assigned to the NFT.

The token transaction unit may restrict authority to download NFT content-related supporting documents, access big data, search for information, and information inquiry and transaction according to the share ratio information of the rights holder and other users.

The token transaction unit may collect share information, marketable share information, and price information corresponding to a share for the NFT content received from a user terminal of the rights holder, and perform a transaction for the NFT based on the collected share information, the marketable share information among total shares, and the price information.

When the token transaction unit receives a request for NFT transaction and ownership transfer from the user terminal of the rights holder, the token transaction unit may perform authentication by using a unique key included in the NFT, and then performs the NFT transaction and the ownership transfer between the rights holder and the other users on a network.

When the digital wallet management unit receives a request for blocking information change for the NFT from a user terminal of the rights holder, the digital wallet management unit may move a corresponding NFT from a hot wallet to a cold wallet.

When profit for the NFT content is generated, the digital wallet management unit may distribute a copyright fee to the rights holder in proportion to a share ratio.

According to the present disclosure, it is possible to have integrity and permanence of copyright information and profit distribution contract relationship based on blockchain, calculate an appropriate amount by having representative shareholders and participants directly determine an NFT price, and fundamentally resolve indiscriminate fraud and transaction.

### BRIEF DESCRIPTION OF THE DRAWINGS

FIG. 1 is a diagram illustrating an ownership and copyright integrating non-fungible token (NFT) system according to an embodiment of the present disclosure.

FIG. 2 is a configuration diagram illustrating an ownership and copyright integrating NFT system according to an embodiment of the present disclosure.

FIG. 3 is a flowchart illustrating an ownership and copyright integrating NFT transaction method using an ownership and copyright integrating NFT system, according to an embodiment of the present disclosure.

FIG. 4 is an example diagram illustrating an operation of a token transaction unit.

### DETAILED DESCRIPTION OF THE INVENTION

Hereinafter, embodiments of the present disclosure will be described in detail with reference to the attached drawings such that those skilled in the art may easily implement the present disclosure. However, the present disclosure may be implemented in various different forms and is not limited to the embodiments described herein. In addition, in order to clearly describe the present disclosure with reference to the drawings, parts that are not related to the description are omitted, and similar parts are given similar reference numerals throughout the

### Specification.

Throughout the specification, when a part is said to “include” a certain component, this does not mean that other components are excluded, but rather that other components may be further included, unless otherwise specifically stated.

Then, embodiments of the present disclosure will be described in detail with reference to the attached drawings such that those skilled in the art may easily implement the present disclosure.

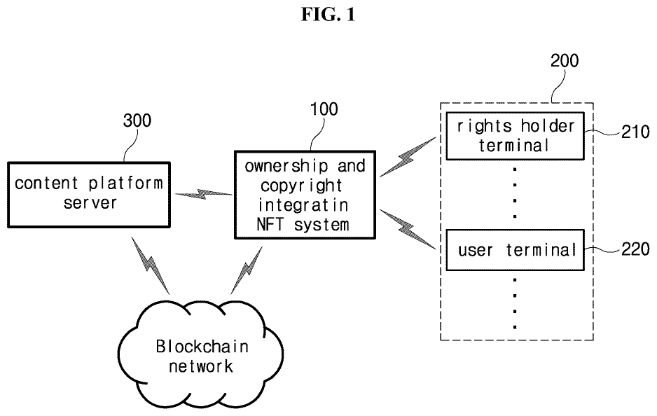

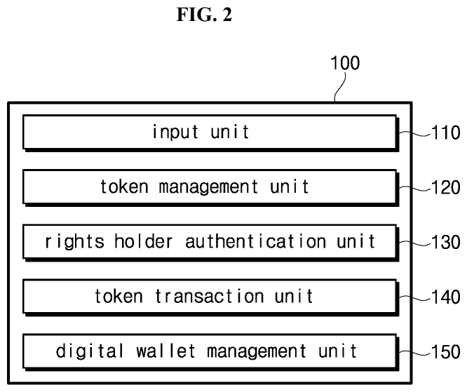

Hereinafter, an ownership and copyright integrating non-fungible token (NFT) system according to an embodiment of the present disclosure will be described in more detail with reference to FIG. 1 and FIG. 2.

FIG. 1 is a diagram illustrating an ownership and copyright integrated NFT system according to an embodiment of the present disclosure.

As illustrated in FIG. 1, an ownership and copyright integrating NFT system 100 according to an embodiment of the present disclosure is connected to a user terminal 200 and a content platform server 300 through a network, and performs a transaction by integrating and granting ownership and copyright for NFTs at the same share ratio.

Here, the user terminal 200 includes a rights holder terminal 210 owned by a rights holder who is granted ownership and copyright for NFT content, and a user terminal 220 owned by a user who subscribes to NFT content.

The rights holder terminal 210 and the user terminal 220 are portable user terminals and may be implemented as devices, which may be connected to a network wired or wirelessly and exchange information, such as a laptop computer, a workstation, a palmtop computer, a web pad, or a mobile communication terminal.

Next, the content platform server 300 may be a platform server providing content that is digitally generated and processed in all forms of creative works, such as text, music, and video.

For example, the content platform server 300 includes the existing music platforms such as music, melon, and genie, and a video platform such as YouTube, and a game platform such as Minecraft.

In addition, the ownership and copyright integrating NFT system 100 is connected to the content platform server 300 through a blockchain network.

FIG. 2 is a configuration diagram illustrating the ownership and copyright integrating NFT system according to the embodiment of the present disclosure.

As illustrated in FIG. 2, the ownership and copyright integrating NFT system 100 includes an input unit 110, a token management unit 120, a rights holder authentication unit 130, a token transaction unit 140, and a digital wallet management unit 150.

First, the input unit 110 receives NFT information on content based on an NFT.

The token management unit 120 generates an NFT matching the received NFT information and provides history information of the generated NFT according to a request of a rights holder or a user.

The rights holder authentication unit 130 grants a share to the generated NFT, and integrates ownership and copyright in the same share ratio and provides the integrated ownership and copyright to a user corresponding to the NFT.

When the token transaction unit 140 receives a transaction request signal for an NFT from a rights holder, the token transaction unit 140 trades the NFT with another user according to the received transaction request signal. In addition, the token transaction unit 140 generates a history for the NFT for which the transaction is completed and broadcasts the generated history to the blockchain network.

Finally, the digital wallet management unit 150 collects NFT information held by multiple rights holders and usage rights information set by a rights holders or a user. When profit is generated for NFT content by the content platform server 300, the digital wallet management unit 150 extracts the NFT information matching the NFT content and distributes copyright fees to the rights holders in proportion to the share ratio included in the extracted NFT information.

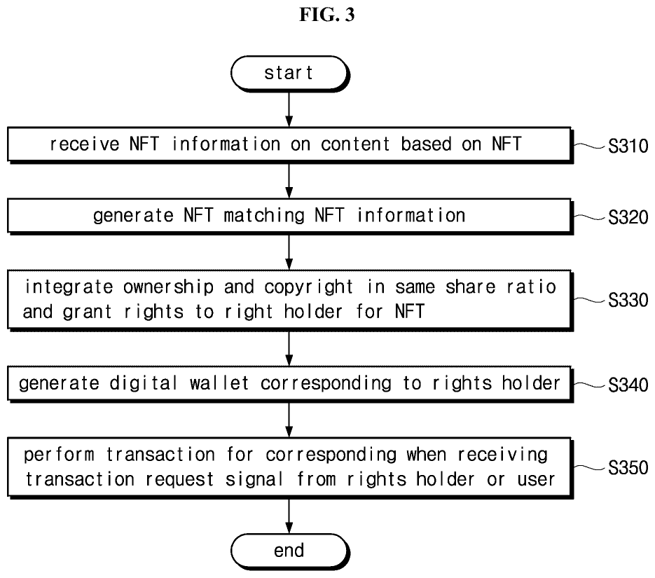

Hereinafter, an ownership and copyright integrating NFT transaction method using an ownership and copyright integrating NFT system, according to an embodiment of the present disclosure, will be described in more detail with reference to FIG. 3.

FIG. 3 is a flowchart illustrating an ownership and copyright integrating NFT transaction method using an ownership and copyright integrating NFT system, according to an embodiment of the present disclosure.

As illustrated in FIG. 3, the ownership and copyright integrating NFT system 100 according to the embodiment of the present disclosure receives NFT information on content based on an NFT from multiple producers (S310).

Here, the NFT information includes at least one of content information including an image, a video, music, modeling, digital real estate, and a game, information in which copyright and ownership of content are integrated, and share ratio information of a rights holder and other users.

Next, the token management unit 120 generates an NFT matching the received NFT information (S320).

In detail, the token management unit 120 generates an NFT that matches one-to-one to at least one of an image, a video, music, modeling, digital real estate, and a game. In this case, a certain unique key is assigned to the generated NFT.

In addition, the rights holder authentication unit 130 integrates ownership and copyright in the same share ratio and grants rights to a rights holder for the generated NFT (S330).

It does not give substantial meaning to an owner who purchases the existing NFT content. That is, the owner acquires ownership of the NFT content but may not exercise substantial rights.

Therefore, in the embodiment of the present disclosure, the concept of ownership and copyright for NFT content is completely integrated. For example, assuming that the ownership share of NFT content is 1 %, a 1% share of ownership has the same concept as a 1% share of copyright.

Hereinafter, in order to explain that the ownership and copyright of NFT content are integrated and delegated authority, a producer is named as a “rights holder”.

The rights holder authentication unit 130 transmits the granted rights holder's share information to the token management unit 120. Then, the token management unit 120 collects an NFT and the corresponding rights holder's share information, and broadcasts the rights holder information and share information for the collected NFT to a blockchain network.

In addition, the digital wallet management unit 150 generates a digital wallet corresponding to the rights holder (S340).

The digital wallet collects NFTs matching the copyright asset. In addition, the digital wallet management unit 150 restricts usage rights for the digital wallet by using a set value.

To explain this again, the digital wallet management unit 150 authority to download NFT content-related supporting documents, access big data, search for information, and information inquiry and transaction according to the share ratio information of the rights holder and other users.

In the embodiment of the present disclosure, it is described that the digital wallet is generated only for the rights holder, but the digital wallet is generated for a user as well.

Meanwhile, when a request to block an information change for the NFT is received from the rights holder terminal 210, the digital wallet management unit 150 may move the corresponding NFT from a hot wallet to a cold wallet.

Also, the digital wallet management unit 150 distributes the profit generated for the NFT content to each rights holder in proportion to the owned share ratio.

When receiving a transaction request signal from a rights holder or user after step S340 is completed, the token transaction unit 140 performs a transaction for the corresponding NFT through the metaverse platform (S350).

The rights holder may set a sale share among the owned shares and set a price corresponding to the sale share.

When a transaction for some or all of the sale shares is to be performed, the rights holder or user inputs the share information of the NFT to be sold or purchased through the user terminal 200. Then, the token transaction unit 140 performs authentication by using a unique key of the corresponding NFT. Here, the authentication of the unique key is to prevent external access or abnormal access.

Then, the token transaction unit 140 performs an NFT transaction between the rights holder who requests the transaction and another user, and when the transaction for the token is completed, transaction completion information is generated and broadcasted to a blockchain network.

Share change information according to the transaction completion is transmitted to the token management unit 120, and the token management unit 120 stores the received share change information in a transaction and broadcasts the received share change information to the blockchain network.

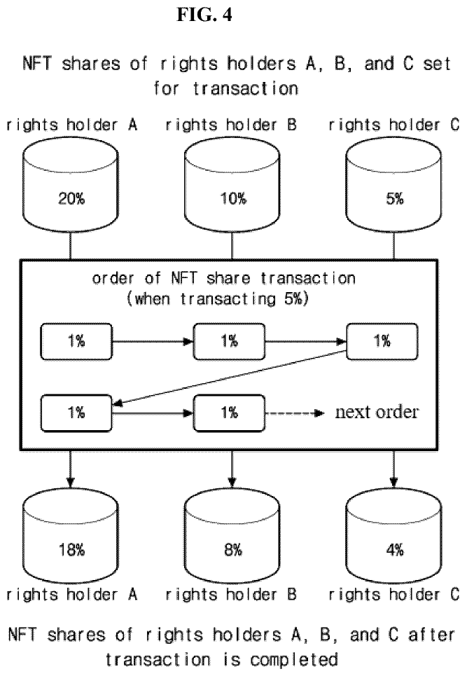

Hereinafter, an operation of the token transaction unit 140 will be described in detail with reference to FIG. 4.

FIG. 4 is an example diagram illustrating the operation of the token transaction unit 140.

The token transaction unit 140 according to the embodiment of the present disclosure sequentially rotates the shares for the requested transaction and performs the sale when multiple rights holders request a sale for token transaction.

For example, it is assumed that the ownership shares of a rights holder A, a rights holder B, and a rights holder C are respectively 50%, 30%, and 20% as illustrated in FIG. 4, the rights holder A wants to sell 20% of the total share, the rights holder B wants to sell 10% of the total share, and the rights holder C wants to sell 5% of the total share.

According to the conventional technology, the share of a rights holder who first requests the sale is traded first, and then the share of a rights holder who requests the sale later is traded, but according to the present disclosure, shares are traded sequentially for all rights holders.

According to the embodiment of the present disclosure, the token transaction unit 140 may sell the same shares that the rights holders A, B, and C want to sell while performing a sequential rotation, as illustrated in FIG. 4.

In this case, the minimum transaction unit of shares is 0.01%, and multiple rights holders may sell the shares by performing a sequential rotation in units of 1%.

Therefore, the rights holder A, the rights holder B, the rights holder C may sell their shares by 1% for each of the holders in order of the rights holder A, the rights holder B, the rights holder C.

For example, the rights holder A may sell 0.37% of the share to a rights holder D, and then sell 0.63% of the share to a rights holder E, and then sell 0.15% of the share to the rights holder B, and then sell 0.85% of the share to a rights holder F.

In addition, the token transaction unit 140 may perform sales in proportion to a share ratio owned by multiple rights holders while performing a sequential rotation.

In the example of FIG. 4, assuming that ownership shares of the rights holders A, B, and C are respectively 50%, 30%, and 20%, the rights holders A, B, and C may sequentially sell their shares at a ratio of 5:3:2.

That is, the rights holder A may sell 2.5% of the share, then the rights holder B may sell 1.5% of the share, and then the rights holder C may sell 1% of the share. Then, the rights holder A may sell the share owned by the rights holder again.

Meanwhile, among multiple rights holders, the rights holder with the largest share, such as the representative copyright holder, may directly determine the price per % of the share. Therefore, in the above example, the rights holder A is the largest shareholder, and accordingly, the rights holder A directly determines the price per 1% of the share and the price per 1% of the share is automatically notified to the other rights holders, such as the rights holder B and the rights holder C.

In this case, the other rights holders, such as the rights holder B and the rights holder C, may each determine a range of the price per 1% of the share to be sold.

In addition, when the share price determined by the rights holder A is included within a price range set directly by each of the rights holder B and the rights holder C, share transactions of the rights holder B and the rights holder C are automatically activated, and when the determined share priced is not included, the setting of the transaction activation of the rights holder B and the rights holder C is automatically released and deactivated.

In a case where the rights holders B and C do not determine on the range of price per % of shares to be sold, when the largest shareholder, that is, the rights holder A, agrees on the price per 1% of the shares, the shares transactions of the rights holders B and C are activated, and when the rights holder A does not agree, the share transactions of the rights holders B or C are deactivated.

In addition, in a state where the largest shareholder, that is, the rights holder A determines the price per % of the share, when the largest shareholder does not engage in any transaction for a certain period of time, the setting of transaction activation of all rights holders including the rights holder B and the rights holder C are released, and through an automatic valuation method, the share price is determined based on an average profit of the corresponding content for a certain period of time.

That is, when the rights holder A who is the largest shareholder do not conduct any transactions for more than 3 years due to death or other reasons, the share price is determined based on an average profit of the content for 10 years through the automatic valuation method.

In this way, when the automatic valuation method is used, the rights holder B and the rights holder C may each reset the shares for transaction to request a sale.

That is, in the example of FIG. 4, when the rights holder B wants to sell 10% and the rights holder C wants to sell 5%, the percentage of shares to be sold is initialized and may be set again through the automatic valuation method.

Meanwhile, in the state where the automatic valuation method is used, even when the rights holder A, who has the largest share, does not engage in transaction for a certain period of time, the setting of transaction activation for all rights holders, including other rights holders B and C, are maintained as it is.

According to an embodiment of the present disclosure, copyright transactions are made directly on the metaverse through the API, real-time transactions may be made with only the share price and transaction activity share information, and when the representative copyright holder performs public setting, an annual income of the representative copyright holder may also be checked. The above functions are provided to a person having an integrated copyright and ownership system account, and in this case and may include information necessary for identity authentication, copyright, and settlement. Therefore, a person having an integrated copyright and ownership system account may trade copyright in the same manner as in any metaverse platform.

In this way, the ownership and copyright integrating NFT system according to the present disclosure may have integrity and permanence of copyright information and profit distribution contract relationship based on blockchain, calculate an appropriate amount by having representative shareholders and participants directly determine an NFT price, and fundamentally resolve indiscriminate fraud and transaction.

The present disclosure is described with reference to the embodiments illustrated in the drawings, but these are merely examples, and those skilled in the art will understand that various modifications and equivalent other embodiments may be derived therefrom. Therefore, the true technical protection scope of the present disclosure should be determined by the technical idea of the attached patent claims.

### REFERENCE SIGNS LIST

100: ownership and copyright Integrating NFT System
110: input unit
120: token management unit
130: rights holder authentication unit
140: token transaction unit
150: digital wallet management unit
200: user terminal
210: rights holder terminal
220: user terminal
300: content platform server

1. An ownership and copyright integrating non-fungible token (NFT) system based on blockchain in a metaverse platform, the ownership and copyright integrating NFT system comprising:
an input unit configured to receive NFT information on content based on an NFT;
a token management unit configured to generate an NFT matching the received NFT information and provide a history management service for the NFT;
a rights holder authentication unit configured to integrate ownership and copyright in an equal share ratio and providing the integrated ownership and copyright to a user corresponding to the generated NFT; and
a token transaction unit configured to perform NFT transaction with other users on the metaverse platform by using transaction information input by a rights holder to whom the ownership and copyright are provided, generate transaction completion information when NFT transaction is completed, and broadcast the transaction completion information to a blockchain network,
wherein the token transaction unit performs a sale for shares of a requested transaction while performing a sequentially rotation when multiple rights holders request a sale for token transaction.

2. The ownership and copyright integrating NFT system of claim 1, further comprising:
a digital wallet management unit configured to collect NFT information held by the multiple rights holders and usage rights information on digital wallets set by each of the multiple rights holders and configured to perform conversion management between a hot wallet and a cold wallet.

3. The ownership and copyright integrating NFT system of claim 1, wherein
the token transaction unit performs the sale in an equal share unit of the multiple rights holders while performing the sequential rotation.

4. The ownership and copyright integrating NFT system of claim 1, wherein
the token transaction unit performs the sale in proportion to share ratios owned by the multiple rights holders while performing the sequential rotation.

5. The ownership and copyright integrating NFT system of claim 3, wherein
a minimum transaction unit of the shares is 0.01%, and the multiple rights holders performs the sale by 1% for each rights holder while performing the sequential rotation.

6. The ownership and copyright integrating NFT system of claim 4, wherein
a minimum transaction unit of the shares is 0.01%, and the multiple rights holders performs the sale by 1% for each rights holder while performing the sequential rotation.

7. The ownership and copyright integrating NFT system of claim 1, wherein
the token transaction unit automatically notifies other rights holders of share price per % when a largest share holder among the multiple rights holders determines the share price per %, automatically activates a transaction of a corresponding rights holder when the share price per % is included in a share price range directly set by another rights holder, and automatically deactivates transaction activation setting for the corresponding rights holder when the share price per % is not included in the set share price range.

8. The ownership and copyright integrating NFT system of claim 7, wherein
the token transaction unit deactivates the transaction of another rights holder who does not agree with the share price per % when the largest share holder among the multiple rights holders determines the share price per %.

9. The ownership and copyright integrating NFT system of claim 8, wherein,
when the largest share holder is not engaged in the transaction for a certain period of time while the share price per % is determined, the token transaction unit releases the transaction activation settings of all rights holders and determines the share price per % based on an average profit of a corresponding content for a certain period of time for the content through an automatic valuation method.

10. The ownership and copyright integrating NFT system of claim 9, wherein,
in the automatic valuation method, each rights holder sets the shares for transaction again to request a sale.

11. The ownership and copyright integrating NFT system of claim 10, wherein,
in the automatic valuation method, transaction activation settings of all rights holders are maintained even when the largest share holder is not engaged in the transaction for a certain period of time.

12. The ownership and copyright integrating NFT system of claim 1, wherein
the NFT information includes at least one of content information including an image, a video, music, modeling, digital real estate, and a game, information in which copyright and ownership of content are integrated, and share ratio information of a rights holder and other users.

13. The ownership and copyright integrating NFT system of claim 12, wherein
the token management unit generates an NFT to which a random unique key is assigned in response to the NFT information, matches the generated NFT to integrated copyright and ownership information, and stores the matched information, and detects external access or abnormal access by using the random unique key assigned to the NFT.

14. The ownership and copyright integrating NFT system of claim 13, wherein
the token transaction unit restricts authority to download NFT content-related supporting documents, access big data, search for information, and information inquiry and transaction according to the share ratio information of the rights holder and other users.

15. The ownership and copyright integrating NFT system of claim 14, wherein
the token transaction unit collects share information, marketable share information, and price information corresponding to a share for the NFT content received from a user terminal of the rights holder, and performs a transaction for the NFT based on the collected share information, the marketable share information among total shares, and the price information.

16. The ownership and copyright integrating NFT system of claim 15, wherein,
when the token transaction unit receives a request for NFT transaction and ownership transfer from the user terminal of the rights holder, the token transaction unit performs authentication by using a unique key included in the NFT, and then performs the NFT transaction and the ownership transfer between the rights holder and the other users on a network.

17. The ownership and copyright integrating NFT system of claim 2, wherein,
when the digital wallet management unit receives a request for blocking information change for the NFT from a user terminal of the rights holder, the digital wallet management unit moves a corresponding NFT from a hot wallet to a cold wallet.

18. The ownership and copyright integrating NFT system of claim 17, wherein,
when profit for the NFT content is generated, the digital wallet management unit distributes a copyright fee to the rights holder in proportion to a share ratio.
